(19) United States
(12) Patent Application Publication
(10) Pub. No.: US 2022/0054361 A1
(43) Pub. Date: Feb. 24, 2022

(54) ORAL APPLIANCE AS SWALLOWING AUXILIARY DEVICE WITH COVERAGE OF MAXILLARY TEETH AND A MANUFACTURING METHOD THEREOF

(71) Applicant: YI-YUEH LIN, KAOHSIUNG CITY (TW)

(72) Inventor: YI-YUEH LIN, KAOHSIUNG CITY (TW)

(21) Appl. No.: 17/405,675

(22) Filed: Aug. 18, 2021

(30) Foreign Application Priority Data
Aug. 19, 2020 (TW) 109128256

(51) Int. Cl. A61J 7/00; A61C 9/00

(52) U.S. Cl. CPC A61J 7/0061; A61C 9/0053

(57) ABSTRACT

An oral appliance as swallowing auxiliary device with coverage of maxillary teeth and a manufacturing method thereof are provided. The oral appliance comprises a retention framework and a palatal pad. The retention framework is manufactured according to the surface of maxillary dentition, and some case according to the surface of gingiva around the maxillary teeth together. The palatal pad corresponds to the swallowing and pronouncing functional position of tongue and palate. The oral appliance in the present invention is made by a first material and a second material, such as elastic and resiliently soft material, and it obtains well retention force by the material embracing the undercut between the path of insertion of the device and the surface of maxilla teeth or gingiva around the maxillary teeth. The oral appliance can get well retention to withstand the swallowing force and improve the functional performance as maximum tongue pressure, thereby improving the oral intake function and facilitating the dysphagia rehabilitation.

### BACKGROUND OF THE INVENTION

### (a) Field of the Invention

The present invention relates to an oral appliance as swallowing auxiliary device with coverage of maxillary teeth and a manufacturing method thereof, and more particularly to a swallowing auxiliary device that is characterized in being mounted on the teeth of maxillary dental arch. The oral appliance is made by two materials, a first material such as an elastic material and a second material such as a resiliently soft material, and it obtains well retention force by the material embracing the undercut between the path of insertion and the surface of maxillary teeth or gingiva around the maxillary teeth. Thus, the oral appliance can get well retention to withstand the chewing or swallowing force, increase the functional performance as maximum tongue pressure, and improving the oral intake function and facilitating the dysphagia rehabilitation thereof.

### (b) Description of the Prior Art

The phases involved in normal swallowing process include the pre-oral phase, oral phase, pharyngeal phase, and the esophageal phase, whereby saliva or chewed food is caused to enter the stomach through the coordinated application of action and force of muscles in each phase of the swallowing process. When swallowing in the pre-oral and oral phase, the tongue rotates and presses up on the palate that produces a pressure. People with well preformed swallowing function can achieving a maximum tongue pressure over 30kPa, and it may go to 90kPa or higher. The hope is that old people can also achieve a preferred maximum tongue pressure of more than 20kPa to enable performing the safety swallowing function, 30kPa to enable performing the optimum swallowing function cause saliva, liquid, and bolus formed from saliva and chewed food can be well pressed to the pharynx in order to activate the subsequent swallowing reflex processes.

In a situation whereby a patient is unable to swallow normally, which medically known as dysphagia, and symptoms of dysphagia occurs in the pre-oral and oral phase include: inadequate tongue movement occurs during chewing and swallowing, two to three swallows of each mouthful of food are required in order to complete swallowing of all the food, some food has accumulated as debris residue on palate, on the tongue surface, and on the mucosa of the oral cavity after having eaten a meal, usually cause poor oral hygiene. The main factor resulting in the above-described symptoms derives from the patient effecting inadequate pressure when their tongue presses up on the palate and prepares to use a pressure difference to cause food bolus in oral cavity to enter the pharynx. Actual measurement of maximum tongue pressure of patients with dysphagia is generally an inadequate pressure, may below 30kPa, even below 20kPa. Dysphagia easily occurs if the muscles of oral function used in swallowing are weakened, especially muscle of tongue.

Thus, in order to help patients, restore their swallowing function, treatment methods include direct swallowing rehabilitation training, it means patient swallow saliva, modified liquid, or modified food during training, and we can use of an auxiliary device for better swallowing progress. Such as tongue holding method, the patient can do a training exercise as tightly closes their two lips to hold the protruded tongue and do saliva swallowing, that can enhance the endurance and power of tongue muscle. During direct swallowing rehabilitation training, oral appliance can be an auxiliary device to help the swallowing progress. Whereby the swallowing ability of the patient can be restored progressively by the swallow training.

An auxiliary device is mainly a palatal pad placed on the palate in the oral cavity of a patient, which makes the oral cavity space smaller, shortens the distance for the tongue rotate and press upward, the thereby enabling the tongue to apply a greater tongue pressure (greater better for well performed swallowing function) and enable swallowing to smoothly progress in the oral cavity section. A patient trains with the auxiliary device placed in their oral cavity, the power and endurance of tongue muscle may increase progressively. After a period of training, about one to three months, we can measure whether or not the patient's maximum tongue pressure is larger than 30kPa without wearing the oral appliance as auxiliary device and evaluates whether or not the patient no longer needs to wear the auxiliary device and is able to swallow normally by themselves. One type of oral appliance device is formed as a hard resin palatal pad with a thickness, which is hooked in place on the teeth by means of metal fixing hooks, thereby fixing the palatal pad in the oral cavity. However, the oral cavity shape of the patient (such as the gum shape asymmetry, tooth axis may be tilting, malalignment dentition) is not generally completely symmetrical, having portions that are crooked. And conventional metal fixed hooks and palatal pad material has poor elasticity, thus unable to adequately deform in the placement procedure to accommodate the oral cavity shape of some patients with malalignment teeth. It is difficult to get a proper path of insertion in these situations. Sometimes, some teeth need to be extracted in order to accommodate the path of insertion for placement procedure of the auxiliary device. In addition, when the occlusal surface of the teeth of the maxillary dental arch and the occlusal surface of the teeth of lower dental arch proceed with occlusal action, the metal fixing hooks used to hook onto the occlusal surface of the teeth create a hindrance, after multiple reuse in a period of time, the metal fixing hooks, such as metal wire hooks, may possibly break and come apart during chewing or swallowing in oral cavity, and may cause injuries to the patient, even aspiration or inadvertently swallowing of the metal fixing hooks. Another type of oral appliance as auxiliary device is like the shape of a hard resin complete denture or partial denture and includes a mounting portion and a palatal pad. The hard resin palatal pad has an augmentation thickness and is mounted onto the teeth using the mounting portion, thereby fixing the auxiliary device in the oral cavity. However, this type of auxiliary device has the same shortcoming of being made from material of poor elasticity, and thus unable to adequately deform to accommodate the oral cavity shape of patients with maxillary dentition, resulting in the problem of getting a proper path of insertion for proper retention force of the device in oral cavity. Moreover, because this type of auxiliary device is mounted on the denture, the occlusal force on the teeth of denture makes the device move unstable, especially when the patient's occlusion is malocclusion, which may cause pain of oral mucosa and affects the patient's willingness to use and degree of comfortability when in use.

The inventor of the present invention had made an invention application for Taiwanese Application Serial Number 108115917 filed May 8, 2019, Oral appliance as swallow training auxiliary device with open occlusal surface of teeth and production method thereof, and the invention approved in Taiwan as Taiwanese Application Serial Number 1704909 filed Sep. 21, 2020. The oral appliance also applied USA invention as application Ser. No. 16869605 filed May 8, 2020. During further clinical observation and research, the inventor finds the further problem that retention and stability of the appliance during swallowing may not enough for some patients with missing teeth of maxillary dentition, so the inventor made newly design oral appliance again, the present invention to solve the problem.

### SUMMARY OF THE INVENTION

Based on the above-described shortcomings of auxiliary devices of the prior art, the present invention provides an oral appliance as swallowing auxiliary device with an elastic retention framework embracing with maxillary teeth which cover the incisal edge and occlusal surface thereof, and the device with a resiliently soft palatal pad being made or adjusted bedside for raising the maximum tongue pressure.

The retention framework generally is a dental arch from, comprises an outer frame, an inner frame, and a bottom frame, which includes a mutually connect for the outer, inner, and bottom frame. The outer frame tightly embraces the external labial or buccal surface of teeth, inner frame tightly embraces the inner lingual surfaces of teeth, the bottom frame tightly contacts the incisive edge or occlusal surface of maxillary teeth. The palatal pad corresponds in shape of palatal space between the tongue and palate of the oral cavity during swallowing function, moreover, the palatal pad on a baseplate of palatal plate is fixed to the inner frame of the retention framework.

Preferably, the palatal pad includes an upper surface and a lower surface. Upper surface of palatal pad corresponds to the shape of palate during swallowing function. Lower surface of palatal pad corresponds to the position of tongue during pronouncing or swallowing function. The pad can be extended from hard palate to soft palate.

Preferably, the retention framework and baseplate of palatal pad are made from said first material, and the palatal pad is modified and finish the form by said second material.

Preferably, if there are some missing teeth in the maxillary dentition, the retention framework covers the mucosa surface of missing teeth area by the baseplate, filling the space between baseplate and mucosa by said second material such as resiliently soft material.

Preferably, the palatal pad includes a baseplate and colloid layers respectively coat on lower surface, or two opposite surfaces of the baseplate.

Preferably, the retention framework and baseplate of palatal pad are made from said first material, such as elastic material like thin thermoplastic resin plate, and the palatal pad is modified and finish the form by said second material, such as resiliently soft material.

Preferably, the inner frame of retention framework can be extended to palate to be baseplate of palatal pad, or we made separate retention framework and separate baseplate of palatal pad.

Preferably, an auxiliary binding structure is disposed on the inner frame and baseplate of palatal pad, and the palatal pad is fixed to the baseplate of inner frame and palatal pad by means of the auxiliary binding structure, with the auxiliary binding structure provided with several holes through these baseplates.

The present invention further provides a manufacturing method for the oral appliance as swallowing auxiliary device with coverage of maxillary teeth, including the following steps:

Producing the retention framework according to the arranged configuration of the teeth of maxillary dental arch.

Preferably, the retention framework is produced by applying said first material on the teeth of maxillary dental arch of a dental stone cast.

Alternatively, the retention framework is produced by firstly obtaining 3D digital data of the maxillary dental arch with gingiva around maxillary teeth, and then we construct a digital model, depicting and shaping the retention framework in the digital model, and produce the retention framework with a 3D printing technology.

Producing the retention framework according to the arranged configuration of the teeth of maxillary dental arch, wherein the retention framework includes the distal end connection between outer frame and an inner frame, that enables embracing coverage of the incisive edge and the occlusal surface of the teeth of maxillary dental arch.

Producing the retention framework according to the arranged configuration of the teeth of maxillary dental arch, may cover the gingiva around the maxillary teeth.

Producing the palatal pad on the baseplate of palatal pad, fixed to the inner frame of retention framework, to match the palate shape in the oral cavity.

Preferably, the palatal pad baseplate can be produced by first forming a baseplate extended from the inner frame of the framework, and then the two opposite surfaces of the baseplate are coated both with the uncured resiliently soft material to be embryonic palatal pad.

Preferably, the embryonic palatal pad includes: a baseplate and uncured colloid layers respectively coated on lower surface, or two opposite surfaces of the baseplate.

Preferably, after fitting the retention framework and impress the embryonic palatal pad on the mucosa of palate, the upper surface of the pad can fit the functional form of palate during patient swallowing. Ask the patient to pronounce and/or swallow, the tongue presses up on the palate during swallowing and shape the lower surface form of the uncured resiliently soft material for palatal pad. Then wait the resiliently soft material cured.

Preferably, a separate palatal pad is produced using said second material, on the separate baseplate of palatal pad, then fixed to the inner frame.

Preferably, the retention framework and palatal pad baseplate template can be produced separately, then fixed together by the colloid layers with bonding holes on both parts. Then the two opposite surfaces of the framework and baseplate are coated both with the uncured resiliently soft material, such as denture soft liner, then it can bind these 2 parts together when the soft material cured to be the resiliently soft colloid layers.

Producing the separate retention framework according to the arranged configuration of the teeth of maxillary dental arch, wherein the retention framework includes the distal end connection between outer frame and an inner frame, that enables coverage of the incisive edge and the occlusal surface of the teeth of maxillary dental arch.

Alternatively, the separate retention framework is produced by firstly obtaining 3D digital data of the maxillary dental arch and gingiva around the teeth, and then we construct a digital model, depicting and shaping the retention framework on the digital model, produce the retention framework with a 3D printing technology.

Alternatively, the separate baseplate of palatal pad or embryonic palatal pad is produced by firstly obtaining 3D digital data of the maxillary palate and tongue, and then depicting and shaping the baseplate of palatal pad or embryonic palatal pad with a 3D printing technology.

Preferably, if we need to reinforce the structure strength of the retention framework in the case that there are some missing teeth in the maxilla dentition, the baseplate of retention framework can include the form of missing teeth and gingiva around the missing teeth, the form from reconstruction wax-up dental stone cast or reconstruction by 3D digital data model, then we fill the space in the framework (space between framework baseplate and mucosa) by said first and second material, cover the mucosa surface of missing teeth area by the retention framework. That can reinforce the structure strength of the framework and prevent framework fracture during chewing and swallowing.

Preferably, the retention framework according to the arranged configuration of the teeth of maxillary dental arch, may be extended to cover some gingiva around the maxillary teeth, so it can get more retention and stability.

Preferably, the separate retention framework according to the arranged configuration of the teeth of maxillary dental arch, may cover the gingiva around the teeth, so it can get more retention and stability.

Based on the above-described technological characteristics, the present invention is preferably able to achieve the following effects:

1. The present invention differs from oral appliance as swallow auxiliary devices of the prior art which made by hard resin, the retention framework of the present invention is made by said first elastic material, such as thin resin plate, and the palatal pad is made from said second material such as resiliently soft material, thus, the entire structure of the device is relatively resiliently soft and elastic, which provides better comfort and enables easier placement within the oral cavity when in use.

2. The present invention is aimed at custom-made, and we use a dental stone cast of the maxilla from dental impression, or 3D digital data obtained from scanning the maxillary dental arch and gingiva around the teeth to make the device. The retention framework generally a dental arch from, comprises an outer frame, an inner frame, and a bottom frame, which includes a mutually connect for the outer, inner, and bottom frame.

The outer frame tightly embraces the external labial or buccal surface of teeth, inner frame tightly embraces the inner lingual surfaces of teeth, the bottom frame tightly contacts the incisive edge or occlusal surface of maxillary teeth. The retention framework embraces the form of the teeth of maxillary dental arch with said first and second material, which facilitates firmly binding the retention framework onto the maxillary dental arch and reduces the sensation of having a foreign body inside the oral cavity when in use.

3. Mounting of the retention framework on the teeth of maxillary dental arch enables good retention thereof. Accordingly, we can utilize elastic and resiliently soft material in proper undercut around the maxilla teeth to get proper retention and stability of the oral appliance. We can adjust the retention force from the amount of undercut, such as adjust the path of insertion, and/or cut off some of the outer frame of retention framework which cover the undercut area. Good retention and stability of the oral appliance during function is very important for patient, whether to speak or chew food, thereby increasing the degree of comfort sensation of patient using the device, improving the patient's willingness to use the device.

4. The palatal pad includes: a baseplate of palatal pad, and colloid layers respectively coated on lower surface, or two opposite surfaces of the baseplate. The baseplate of palatal pad can be an extensional portion of the inner frame of retention framework or be made separately.

5. The palatal pad of the present invention can be custom-made. We can add or remove some thickness of colloid layer on lower surface of the palatal pad to modify the maximum tongue pressure for the safety or proper target of different swallowing training stage. Whereby the patient takes swallowing action and uses their tongue to press up on the lower surface of the embryonic palatal pad, and to make upper side of the embryonic palatal pad shape according to the functional palate form in oral cavity. Hence, the palatal pad can be adapted to match the needs of different patients and different training stage, enabling the swallowing auxiliary device of the present invention to be firmly positioned and stable within the functional oral cavity, thus providing better comfort when in use.

6. If there are some missing teeth in the maxilla dentition, and we need to reinforce the structure strength of the retention framework, in the case that the baseplate of retention framework can include the form of missing teeth and gingiva around the missing teeth, then we fill the space in the framework by baseplate material or resiliently soft material and cover the mucosa surface of missing teeth area by the retention framework. That can reinforce the structure strength of the framework and prevent framework fracture during chewing and swallowing, and that can improve the stability of oral appliance and better comfort of patient during chewing or swallowing function.

7. The retention framework may be extended to cover some gingiva around the maxillary teeth, so it can get more retention and stability.

8. Comparing to the prior art of palatal augmentation pad, made by hard resin, the manufacturing method of the swallowing auxiliary device of the present invention are relatively simple, so we can make it bedside for patient. It can be well done during home healthcare, nursing home healthcare, or facility healthcare.

9. Comparing to the prior art of palatal augmentation pad, made by hard resin and/or hooking metal portion about 3-6 appointment in several weeks, by the manufacturing method of the swallowing auxiliary device of the present invention, we can relatively quickly finish the manufacture procedures about 1-2 appointment in 1-2 days, so we can meet the needs of early dysphagia rehabilitation. The importance of early intervention and training for dysphagia patient had been proved already, such as for stroke patient.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a three-dimensional external view of an oral appliance as swallowing auxiliary device of the present invention not yet being placed inside the oral cavity for shaping, wherein a baseplate of palatal pad is not yet coated with a colloid layer.

FIG. 2 is a three-dimensional external view of an oral appliance as swallowing auxiliary device of the present invention ready to be placed inside the oral cavity for shaping, wherein the baseplate of palatal pad is already coated with colloid layers.

FIG. 3 is a bottom view of FIG. 2.

FIG. 4 is a schematic view depicting fitting the present invention, whereby a patient does not swallow and does not use tongue press up on the embryonic palatal pad yet.

FIG. 5 is a schematic view depicting fitting the present invention, whereby a patient does swallow and uses tongue press up on the embryonic palatal pad, causing the embryonic palatal pad to be molded and shaped the lower surface according to the contour form of the tongue elevation during swallowing, and upper surface according to the functional palate form in the oral cavity.

FIG. 6 is an external view of a swallowing auxiliary device of the present invention fitted on the patient's maxillary dental arch and palate with the shaped palatal pad.

FIG. 7 is a three-dimensional external view of the second manufacturing method for a swallowing auxiliary device of the present invention, the separate retention framework baseplate not yet being placed inside the oral cavity for shaping, wherein it is not yet coated with a colloid layer.

FIG. 8 is a schematic view of the second manufacturing method for an auxiliary binding structure formed on an inner frame of the retention framework of the present invention that firmly connects and fixes the palatal pad by the cured colloid layers.

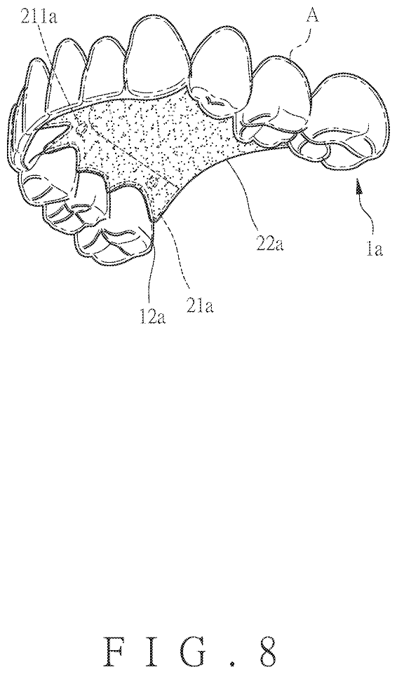

FIG. 9 is a bottom view of FIG. 8.

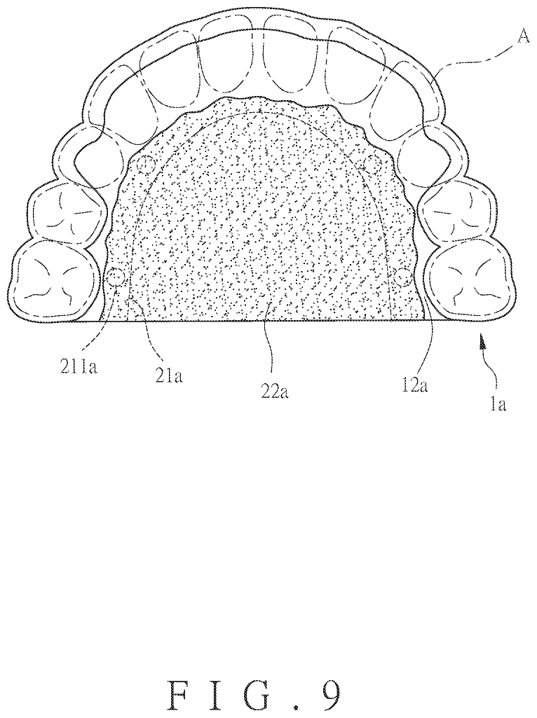

FIG. 10 is a three-dimensional external view of the third manufacturing method for a swallowing auxiliary device of the present invention. There are some missing teeth in the maxilla dentition. The baseplate of retention framework can include the form of missing teeth and gingiva around the missing teeth, then we fill the space in the framework by baseplate material or resiliently soft material and cover the mucosa surface of missing teeth area by the retention framework. The baseplate not yet being placed inside the oral cavity for shaping, wherein it is not yet coated with a colloid layer.

FIG. 11 is a schematic view of the third manufacturing method for a swallowing auxiliary device of the present invention that firmly connects and embraces the maxillary dentition.

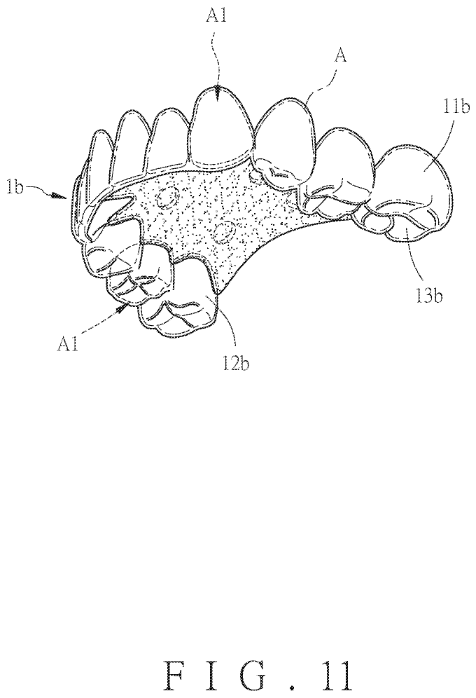

FIG. 12 is a bottom view of FIG. 11.

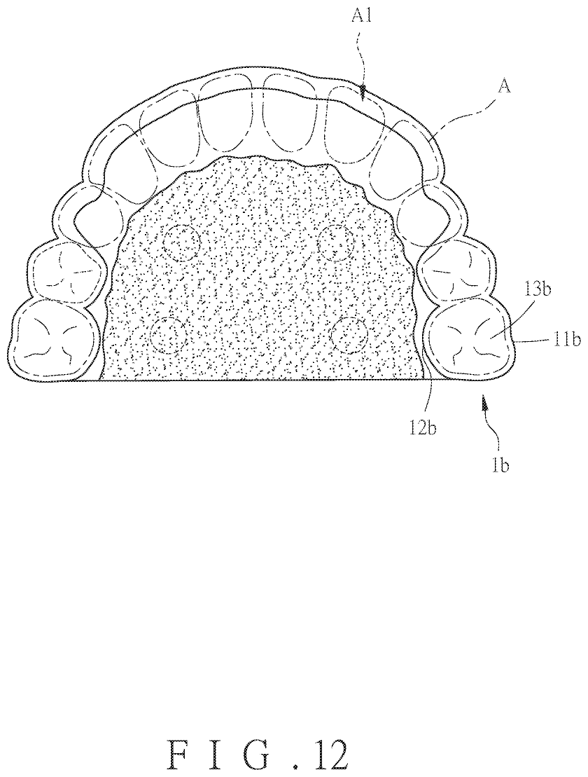

FIG. 13 is a three-dimensional external view of the fourth manufacturing method for a swallowing auxiliary device of the present invention, the baseplate of retention framework is extended to the gingiva around the maxillary teeth. The baseplate not yet being placed inside the oral cavity for shaping, wherein it is not yet coated with a colloid layer.

FIG. 14 is a schematic view of the fourth manufacturing method for a swallowing auxiliary device of the present invention that firmly connects and embraces the maxillary dentition.

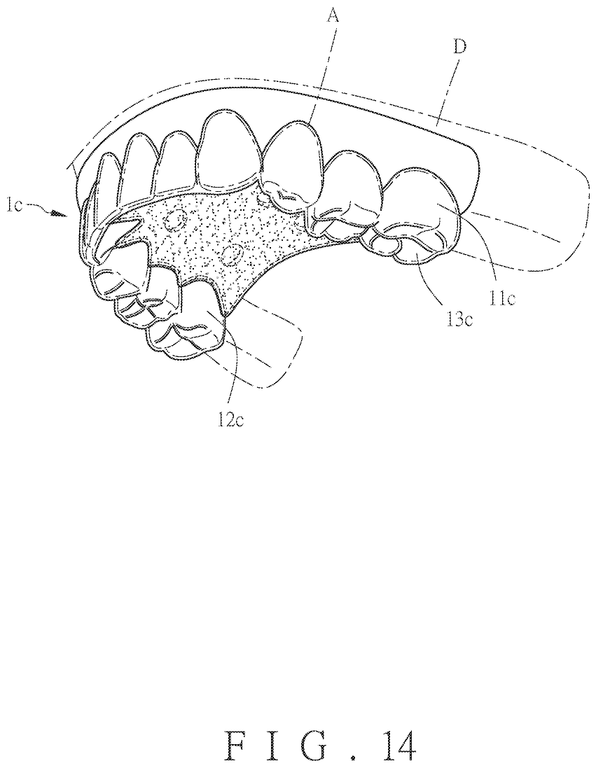

FIG. 15 is a bottom view of FIG. 14.

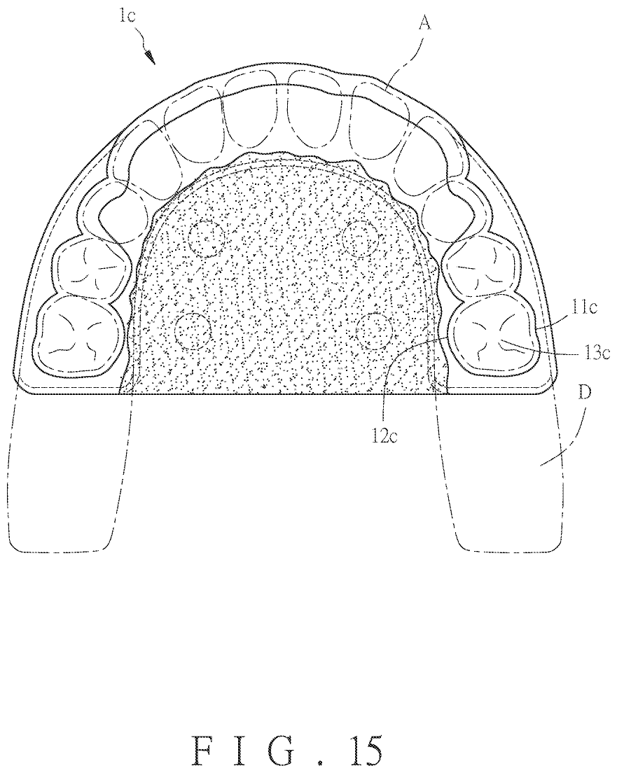

### DETAILED DESCRIPTION OF THE PREFERRED EMBODIMENTS

Based on the above-described technological characteristics of the present invention, the main effects of an oral appliance as swallowing auxiliary device with coverage of maxillary teeth and a manufacturing method thereof are clearly presented in the following embodiments.

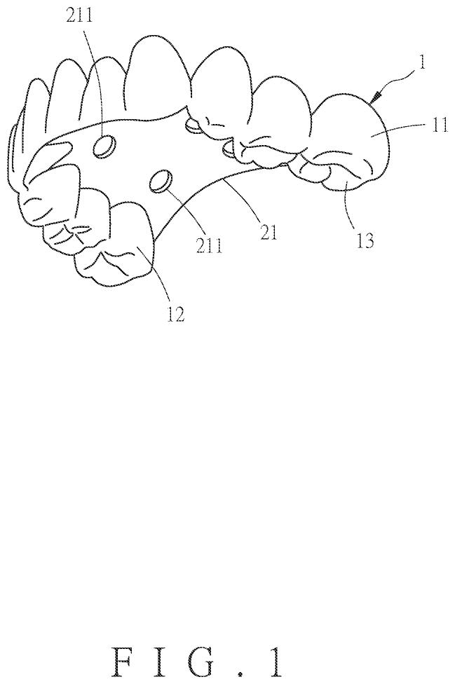

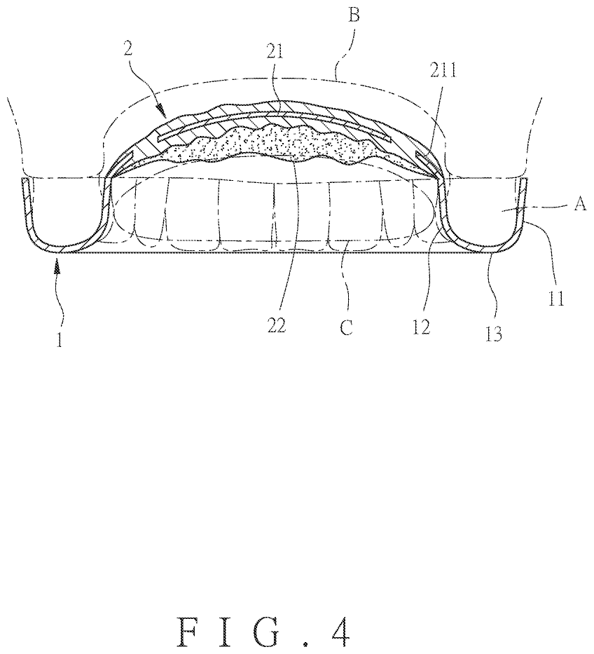

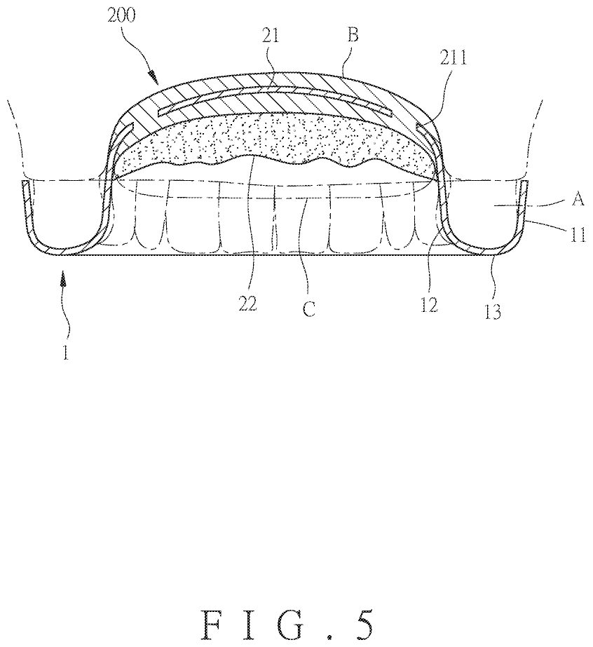

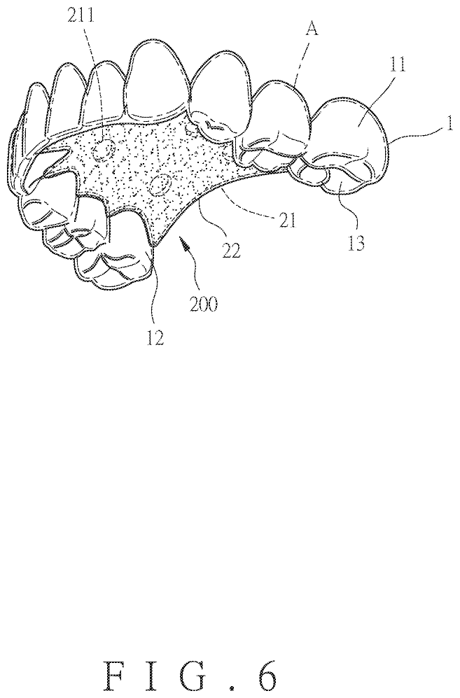

Referring to FIGS. 1 to 6, which show the first manufacturing method of a swallowing auxiliary device of the present invention, being placed and be used inside the oral cavity. There are maxillary dental arch (A), palate (B), and tongue (C) in the oral cavity. (FIGS. 4)

Wherein a retention framework (1) is produced according to the arranged configuration of maxillary dental arch (A) form. A first material, such as elastic material like thin thermoplastic resin plate, is used to shape and produce the retention framework (1). The maxillary dental arch (A) form is according to a dental stone cast, or 3D digital data of the dental arch is first obtained, we construct a digital model, and then a 3D shape of the retention framework (1) is depicted and shaped on the digital model. Then we produce the retention framework by elastic material on the dental cast, or by the 3D printing technology.

Accordingly, the retention framework (1) assumes a dental arch form, which includes an outer frame (11) and an inner frame (12), and a bottom frame (13) that is formed between the outer frame (11) and the inner frame (12).

Then, an un-cured said second material such as resiliently soft material like denture soft liner, is used to make an embryonic palatal pad (2), which is on the baseplate of palatal pad (21) extended from the inner frame (12) of retention framework (1). The material used for the baseplate (21) and the retention framework (1) is made by said first material, such as thin resin plate, and the two opposite surfaces of the baseplate of palatal pad (21) are respectively coated with colloid layers (22), which is an uncured said second material such as resiliently soft material.

In order to enable the colloid layers (22) to firmly bind to the inner frame (12) of the retention framework (1) without easily coming loose, an auxiliary binding structure provided with several through holes (211) is disposed on the inner frame to fix the embryonic palatal pad (2). wherein the auxiliary binding structure of the present embodiment is a spaced arrangement of a plurality of through holes (211) in the baseplate of palatal pad (21). The colloid layers (22) are embedded in the above-described through holes (211) during the process of forming thereof, which firmly binds the colloid layers (22) to baseplate of palatal pad (21) after forming the palatal pad (200) and enables extension the serviceable life of the palatal pad.

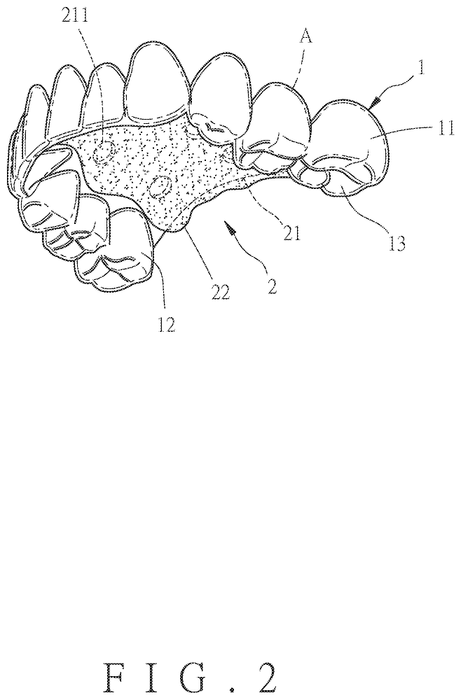

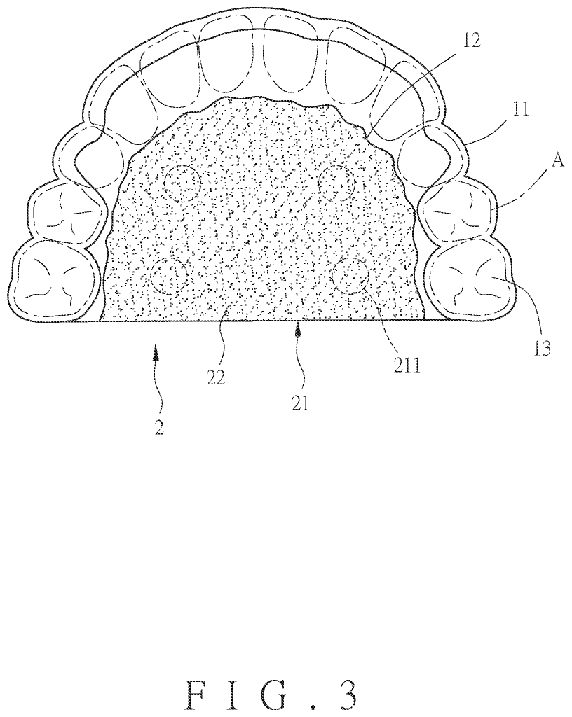

Referring to FIG. 2 and FIG. 3, the retention framework (1) is worn on the maxillary dental arch (A) in the patient's oral cavity, wherein the outer frame (11) tightly embraces the external buccal surfaces of the maxillary dental arch (A), the inner frame (12) tightly embraces the inner lingual surfaces of teeth, the bottom frame (13) tightly contacts the incisive edge or occlusal surface of maxillary teeth, and the embryonic palatal pad (2) can contact the palate (B).

Producing the retention framework (1) according to the arranged configuration of the teeth of maxillary dental arch (A), wherein the retention framework includes the distal end connection between outer frame and inner frame, that enables well embracing coverage of the incisive edge and the occlusal surface of the teeth of maxillary dental arch (A), get a good stability to prevent oral appliance rocking during chewing and swallowing.

The material used for the baseplate of palatal pad (21) and the retention framework (1) is elastic material, and an uncured said second material is used to make an embryonic palatal pad (2), they make the oral appliance soft and elastic, thus providing better comfortable sensation when in use.

Referring to FIGS. 4, 5, 6, which show fitting retention framework (1) of the present invention on maxillary dental arch (A), whereby ask the patient to pronounce and swallow and uses tongue (C) to press up on the embryonic palatal pad (2) , the pressure can shape the embryonic palatal pad (2) form corresponds to the functional position and form of palate and tongue, include the lower surface contacting functional tongue in oral cavity and maxillary surface contacting on the palate (B) mucosa in function. The patient waits for the resiliently soft material shaping and cured, after which the palatal pad (200) is made. The palatal pad (200) can be extended from hard palate to soft palate, it can get more contact surface to palate (B). Since the custom-made present invention fitted on the patient's maxillary dental arch and patient's palate with the shaped palatal pad in function, it can get good embarrassing and stability, thus providing better comfort when in use.

The customized palatal pad (200) can be also adapted to the tongue elevation position during pronouncing and swallowing of different patients or different needs of training. The palatal pad (200) can shorten the distance that tongue (C) presses up on to generate tongue pressure movement to contact and press. Monitoring by maximum tongue pressure measuring device, we can add or remove some thickness of the colloid layer (22) on lower surface of palatal pad (200) to modify the maximum tongue pressure to meet the safety (such as over 20kPa) or proper training needs of different swallowing training stage. If we need to raise the maximum tongue pressure, we can add some thickness of colloid layer (22). After a period of training, such as 1 to 3 months, if the maximum tongue pressure is improved and we need to shift the training goal to more training strength way, we can remove some thickness of colloid layer (22). If the maximum tongue pressure drops down gradually during the long term follow up, we can add some thickness of colloid layer (22). For the safety consideration, the training maximum tongue pressure should over 20kPa with the present invention.

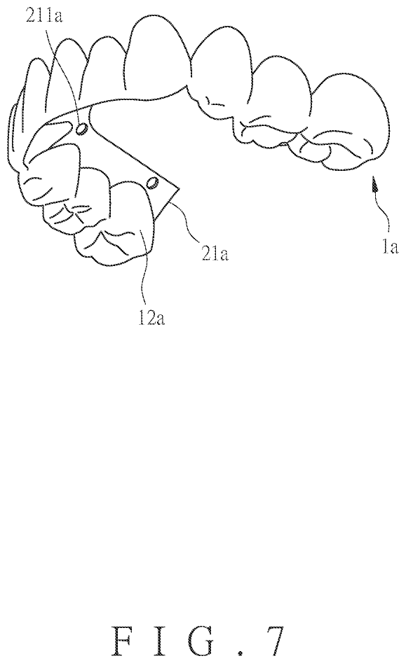

Referring to FIG. 7, 8, 9, the second manufacturing method for a swallowing auxiliary device of the present invention is presented. The retention framework (1a) and baseplate of palatal pad (21a) are made separately. The retention framework is not yet being placed inside the oral cavity in FIG. 7, wherein it is not yet coated with colloid layers. The separate baseplate of palatal pad with or without embryonic palatal pad can be pre-formed by different pre-formed size, or custom-made on maxillary dental cast, or by the digital data obtained from scanning and made by 3D printer. There is auxiliary bonding structure provided with several holes (211a) through the inner frame (12a) of the retention framework (la), and several holes (211) through the separate baseplate of palatal pad (21a). The holes (211,211a) can help the inner frame(12a) bind the separate palatal pad baseplate (21a) with the colloid layers (22a) embedded in the above-described through holes (211a) during the process of forming thereof, which firmly binds the colloid layers (22a) to the inner frame (12a).

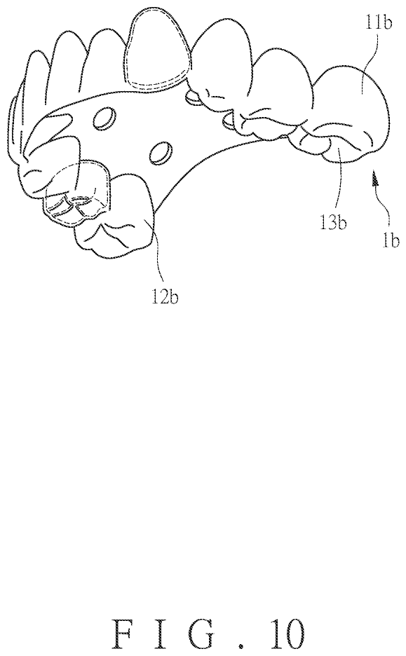

Referring to FIG. 10, 11, 12, the third manufacturing method for a swallowing auxiliary device of the present invention is presented. There are some missing teeth (A1) in the maxillary dental arch (A). During the is missing teeth area, the retention framework (1b) made as the form of missing teeth and gingiva, by wax-up reconstruction dental cast or 3D digital data reconstruction model. The space in the framework, between the outer frame (11b), the inner frame (12b), and the bottom frame (13b), such as the form of missing teeth and gingiva, is filled by said first and second material. That can reinforce the structure strength of the retention framework (1b) and improve the stability and comfortable sensation when use the appliance, prevent framework fracture during chewing and swallowing.

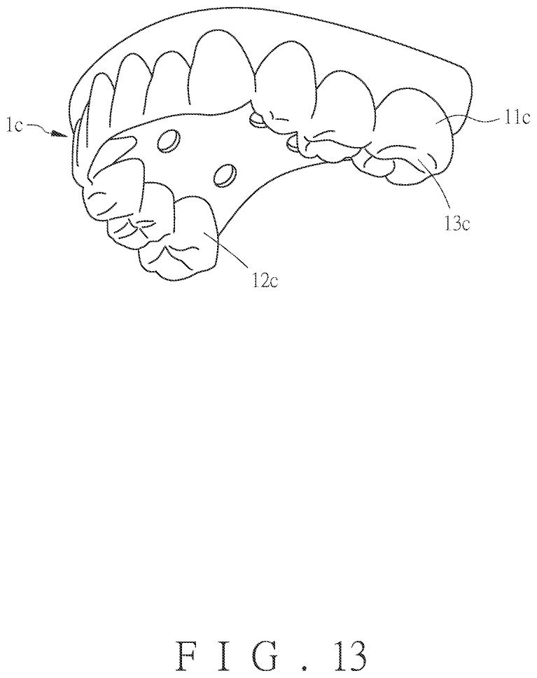

Referring to FIG. 13, 14, 15, the fourth manufacturing method for a swallowing auxiliary device of the present invention is presented. The retention framework (1c) not only cover the maxillary dental arch (A), but also is extended to some gingiva around the maxillary teeth (D). The enhancing coverage and embracing can get more structure strength of retention framework (1c), that can make more retention and stability of the device in oral cavity during chewing and swallowing.

The present invention is a custom-made oral appliance, the retention framework (1,1a,1b,1c) is well fitted and embraces the maxillary dental arch (A), which facilitates firmly binding the retention framework onto the maxillary dental arch and reduces the sensation of having a foreign body inside the oral cavity when in use. Good retention for the oral appliance is very important for patient, whether to speak or chew food, thereby increasing the degree of comfort sensation when in use the device, improving the patient's willingness to use the device.

Mounting of the retention framework (1,1a,1b,1c) on the teeth of maxillary dental arch (A), may some gingiva around the maxillary teeth (D) around the maxillary teeth, enables more retention and stability for the device during oral function.

We can utilize said first and second material, such as elastic and resiliently soft material, in proper undercut around the maxilla teeth for proper retention force. We can adjust the retention force from the amount of undercut, such as adjust the path of insertion, and/or cut off some of the outer frame of retention framework which cover the undercut area of the maxillary dental arch (A).

Comparing to the prior art of palatal augmentation pad, made by hard resin, by the manufacturing method of the swallowing auxiliary device of the present invention we can relatively quickly finish the manufacture procedures to meet the needs of early dysphagia rehabilitation. The importance of early intervention and training for dysphagia patient had been proved already, such as for stroke patient.

The manufacturing method of the swallowing auxiliary device of the present invention is relatively simple, we can make it bedside for patient. It can be well done during home healthcare, nursing home healthcare, or facility healthcare.

In summary, the above description of the embodiments provides a clear understanding of the manufacturing methods and the effectiveness achieved by the present invention. However, it is of course to be understood that the embodiments described herein are merely illustrative of the principles of the invention and that a wide variety of modifications thereto may be affected by persons skilled in the art without departing from the spirit and scope of the invention as set forth in the following claims.

What is claimed is:

1. A swallowing auxiliary device with coverage of maxillary teeth, being placed and used in an oral cavity, there being maxillary dental arch, palate, tongue, and gingiva in the oral cavity, the swallowing auxiliary device comprising:
a retention framework produced according to an arranged configuration form of the maxillary dental arch and configured to embrace the maxillary teeth; and
a palatal pad,
wherein the retention framework includes an outer frame, an inner frame, and a bottom frame, which includes a mutually connect for the outer, inner, and bottom frame,
wherein the outer frame tightly embraces external labial or buccal surface of the maxillary teeth, the inner frame tightly embraces inner lingual surfaces of the maxillary teeth, and the bottom frame tightly contacts incisive edge or occlusal surface of the maxillary teeth,
wherein the palatal pad is bound on the inner frame and corresponds in shape to a palatal space between the tongue and palate of the oral cavity during swallowing function.

2. The device according to claim 1, wherein the palatal pad includes an upper surface and a lower surface, the upper surface of the palatal pad corresponds in shape to the palate during swallowing function; or, the palatal pad extends from hard palate to soft palate during swallowing function.

3. The device according to claim 1, wherein the retention framework is made from a first material, and the palatal pad is made by a second material.

4. The device according to claim 3, wherein there are some missing teeth in maxillary dentition of the oral cavity; the retention framework covers a mucosa surface of missing teeth area, and a space between the outer frame, the inner frame, and the bottom frame is filled with the first material or the second material.

5. The device according to claim 1, wherein the palatal pad includes a baseplate and a colloid layer, the baseplate is formed on the inner frame of the retention framework, and the colloid layer is coated on a lower surface or two opposite surfaces of the baseplate.

6. The device according to claim 5, wherein at least one through hole is provided in the baseplate, and the colloid layer embeds the at least one through hole and is thereby bound on the baseplate.

7. The device according to claim 5, wherein the retention framework and the baseplate of the palatal pad are made from a first material, and the palatal pad is made by a second material.

8. The device according to claim 1, wherein the retention framework is produced on the teeth of the maxillary dental arch of a dental cast from dental impression; alternatively, the retention framework is produced by firstly obtaining 3D digital data of the maxillary dental arch with gingiva around maxillary teeth, and then constructing a digital model, depicting and shaping the retention framework on the digital model, then producing the retention framework with a 3D printing technology.

9. The device according to claim 1, wherein the retention framework includes a distal end connection between the outer frame and the inner frame, which enables well embracing coverage of the incisive edge and the occlusal surface of the teeth of the maxillary dental arch.

10. The device according to claim 1, wherein the retention framework is produced according to the arranged configuration of the teeth of the maxillary dental arch and covers the gingiva around the maxillary teeth.

11. A method for producing a swallowing auxiliary device with coverage of maxillary teeth, placed and used in an oral cavity, there being maxillary dental arch, palate, tongue, and gingiva in the oral cavity, the method comprising:
producing a retention framework according to an arranged configuration form of the maxillary dental arch, the retention framework being configured to embrace the maxillary teeth, wherein the retention framework includes an outer frame, an inner frame, and a bottom frame, which includes a mutually connect for the outer, inner, and bottom frame;
wherein the outer frame tightly embraces external labial or buccal surface of the maxillary teeth, the inner frame tightly embraces inner lingual surfaces of the maxillary teeth, and the bottom frame tightly contacts incisive edge or occlusal surface of the maxillary teeth; and
producing a palatal pad on the inner frame.

12. The method according to claim 11, wherein the palatal pad is connected to the retention framework and includes an upper surface and a lower surface, the upper surface of the palatal pad corresponds in shape to the palate; or, the palatal pad extends from hard palate to soft palate.

13. The method according to claim 11, wherein the retention framework is made from a first material, and the palatal pad is made by a second material.

14. The method according to claim 13, wherein a baseplate is firstly formed on the inner frame of the retention framework, and then uncured said second material is coated on a lower surface of the baseplate, then the palatal pad is formed after said second material is cured; or, the uncured second material is coated on both the upper and lower surfaces of the baseplate, then the palatal pad is formed after said second material is cured.

15. The method according to claim 13, wherein the method further comprises: connecting an embryonic palatal pad made by uncured said second material to the inner frame; asking a patient to wear the retention framework on the maxillary dental arch, and to pronounce or swallow to shape the embryonic palatal pad so that a lower surface of the embryonic palatal pad corresponds in position to the tongue of the oral cavity as the tongue presses upward against the embryonic palatal pad, and that an upper surface of the embryonic palatal pad corresponds in position to a hard palate of the oral cavity, or that the hard palate and a soft palate of the oral cavity jointly shape the embryonic palatal pad; and waiting the embryonic palatal pad cured to be the palatal pad.

16. The method according to claim 13, wherein there are some missing teeth in maxilla dentition of the oral cavity, covers a mucosa surface of missing teeth area, and a space between the outer frame, the inner frame, and the bottom frame is filled with the first material or the second material.

17. The method according to claim 11, wherein the retention framework is produced on the teeth of the maxillary dental arch of a dental cast from dental impression; alternatively, the retention framework is produced by firstly obtaining 3D digital data of the maxillary dental arch with gingiva around maxillary teeth, and then constructing a digital model, depicting and shaping the retention framework on the digital model, then producing the retention framework with a 3D printing technology.

18. The method according to claim 11, wherein the retention framework includes a distal end connection between the outer frame and the inner frame, which enables well embracing coverage of the incisive edge and the occlusal surface of the teeth of the maxillary dental arch.

19. The method according to claim 11, wherein the retention framework is produced according to the arranged configuration of the teeth of the maxillary dental arch and covers the gingiva around the maxillary teeth.
